(19) United States
(12) Patent Application Publication
(10) Pub. No.: US 2013/0270320 A1
(43) Pub. Date: Oct. 17, 2013

(54) DRIVING TOOL

(71) Applicant: Hilti Aktiengesellschaft, Schaan (LI)

(72) Inventors: Thomas Sperrfechter, Gruesch (CH); Peter Bruggmueller, Bludesch (AT)

(21) Appl. No.: 13/860,588

(22) Filed: Apr. 11, 2013

(30) Foreign Application Priority Data
Apr. 13, 2012 (DE) 102012206116.9

(51) Int. Cl. B25C 1/08

(52) U.S. Cl. CPC B25C 1/08
USPC 227/10

(57) ABSTRACT

The invention relates to a driving tool comprising a tank for storing a fuel, a combustion chamber connected to the tank, a movable piston for driving a driving ram, and a ventilator that acts on the combustion chamber and rotates around an axis, with several blades extending radially to the axis, wherein
at least one of the blades has a section of at least one third of a radial length of the blade, whose width projected in the axial direction does not increase radially toward the outside, and/or
at least one of the blades has a section of at least one third of a radial length of the blade, whose angle of inclination (A, B) around a blade axis increases from the outside toward the inside.

### CROSS-REFERENCE TO RELATED APPLICATIONS

This patent application claims the benefit of German Patent Application No. DE 102012206116.9, filed Apr. 13, 2012, which is incorporated by reference.

### TECHNICAL FIELD

The invention relates to a driving tool, particularly a hand-held driving tool, according to the preamble of claim 1.

### BACKGROUND OF THE INVENTION

EP 1 555 090 A1 describes a gas operated driving tool with a combustion chamber, a piston guided in a cylinder and an electrically driven ventilator for generating turbulence in a gas mixture in the combustion chamber. Measures for generating turbulence are proposed that consist in the configuration of axially-protruding structures in the area of the rotor blades.

### BRIEF SUMMARY OF THE INVENTION

The task of the invention is to provide a driving tool that provides a rapid ignition capacity by means of an optimized ventilator.

The task is solved by a driving tool according to the invention as mentioned at the start that has the characterizing features of claim 1. As a result of the proposed measures relating to the blade section that does not broaden toward the outside, a ventilator is selected that has a relatively low moment of inertia or that can be rapidly brought to a useful rpm in the case of a given power. As a result of the blade torsion of the section, which increases toward the interior, a geometry that allows a particularly good generation of turbulence using simple means is alternatively or additionally selected.

The two measures are preferably implemented at the same time, wherein the respective sections of the blade may be identical but do not have to be identical.

In the transition area leading to the hub of the ventilator, the blade inclination can then preferably decrease again, for example, to zero.

In an additional preferred embodiment of the invention, the projected width decreases radially toward the outside over the course of the section, particularly by at least one tenth over the length of the section. As a result, a ventilator that has a particularly small moment of inertia is selected.

In a further detailed representation, optimized in regard to turbulence generation, the increase of the angle of inclination over the section is at least one tenth, particularly at least one fifth, of a maximum angle of inclination of the section.

In a ventilator according to the invention, it is preferred to arrange at least one first blade with a first shaping and at least one second blade with a second shaping that is different from the first shaping. The combination of different blade geometries promotes the generation of turbulence as a result of the breaking up of symmetries, wherein at the same time a low moment of inertia is made possible.

In a general advantageous variant of the invention, at least one of the blades has a radially outer end section, wherein the end section is bent in the axial direction at an angle relative to the remaining blade, preferably by at least ten degrees. Such a bent section generates high turbulence at a great spatial depth already at low rpm values. In the process, the end section can be turned inward to further improve turbulence.

In an additional preferred embodiment, for the purpose of optimizing the generation of turbulence, it is provided that at least one of the blades, particularly all of the blades, has a course with a saber-like curve in the peripheral direction.

An additional shaping of a ventilator according to the invention provides that at least one of the blades comprises a local maximum of the projected width.

### BRIEF DESCRIPTION OF THE SEVERAL VIEWS OF THE DRAWING(S)

Further characteristics and advantages of the invention result from the embodiment examples as well as from the dependent claims. Below, several preferred embodiments of the invention are described and explained further with reference to the appended drawings.

FIG. 1 shows a diagrammatic representation of a driving tool according to the invention.

FIG. 2 shows a diagrammatic view of four different blade shapes of a ventilator of the driving tool of FIG. 1, each according to the invention.

FIG. 3 shows an additional ventilator according to the invention, with two different shapes of blades.

FIG. 4 shows a blade of an additional ventilator according to the invention.

FIG. 5 shows three variants of the blades of a ventilator according to the invention, with bent end areas.

FIG. 6 shows an additional ventilator according to the invention, whose blades have a local maximum of a blade width.

### DETAILED DESCRIPTION OF THE INVENTION

### Embodiment Examples

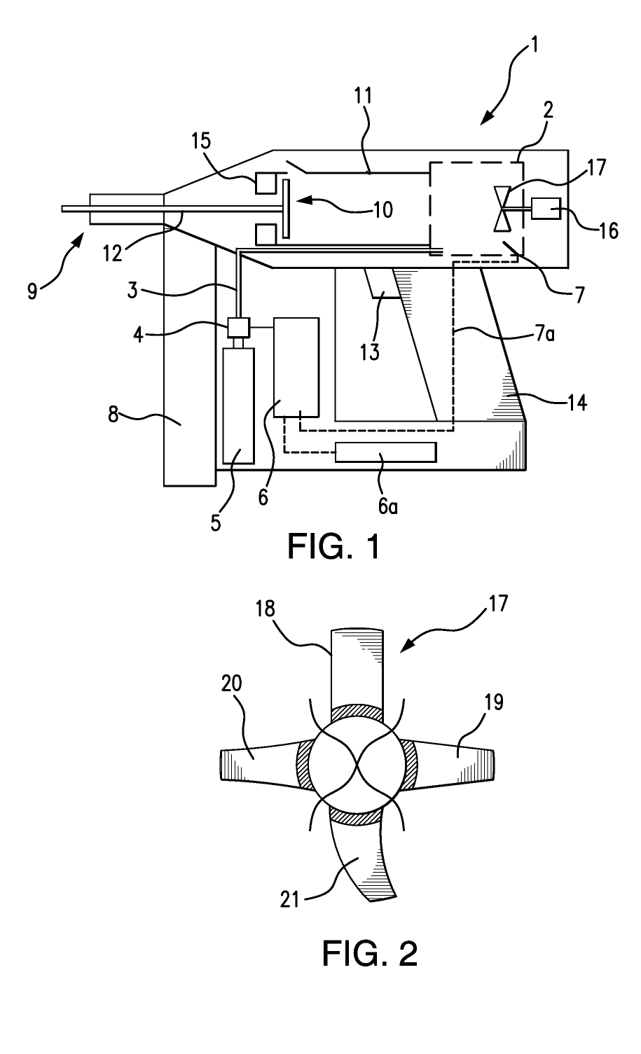

The driving tool shown diagrammatically in FIG. 1 comprises a housing 1 in which a fuel chamber 2 is arranged. Liquid gas is stored as fuel in a fuel container 5 and it can be injected into the combustion chamber 2 through a line 3. The line 3 connects a dosing device 4 to the combustion chamber 2, wherein the dosing device in turn is connected to the fuel container 5 arranged in or on the housing 1. The fuel container can in particular be designed as a replaceable cartridge.

The driving tool additionally comprises an electronic control 6 with an electrical accumulator 6a as energy storage. Through the electronic control 6, an ignition cartridge 7 in the combustion chamber 2 is actuated by means of a line 7a. Moreover, the dosing device 4 is optionally controlled, provided it has electrical valves or other electrically controlled components. In a front area of the driving tool, a magazine 8 for storing fastening means, for example, nails, is arranged. An application element 9 can be pressed against a work piece in order to release a triggering of the driving tool.

The driving of the fastening element out of the magazine 8 occurs via the ignition of a liquid gas-air mixture in the combustion chamber 2 by means of the spark plug 7, after which a piston 10 in a cylinder 11 is driven continuously forward, and it drives the fastening element or the nail into the work piece by means of a driving ram 12. This driving process is triggered by an operator via a switch 13 located primarily in a handle area 14 of the housing 1. The stroke of the piston 10 is limited by an elastic abutment or buffer 15. Prior to ignition, the mixture is distributed in a known manner in the combustion chamber with the assistance of a ventilator 17 driven by an electrical motor 16. The ventilator 17 can also contribute, after the combustion, to flushing the exhaust gases out of the combustion chamber or to cooling the combustion chamber or the driving tool.

A driving tool according to the invention is characterized by a ventilator with an optimized shape.

FIG. 2 shows a ventilator with four different blades 18, 19, 20, 21 shaped according to the invention, with identical shaping of the hub in each case. It should be understood that this is used to illustrate four different embodiment examples.

The upper blade 18 has a nearly rectangular shape. Over nearly the entire blade length, the width is constant in axial projection (axial top view as in FIG. 2).

The right blade 19 is trapezoidal, the projected width narrowing radially toward the outside. The inclination is constant here, so that the blade edges are straight.

The left blade 20 has a similar shape to that of the blade 19, but concavely bent blade edges. Alternatively or additionally, convexly shaped blade edges are also possible.

The lower blade 21 tapers to a relative pointed tip. In addition, its course has a saber-like curve in the peripheral direction.

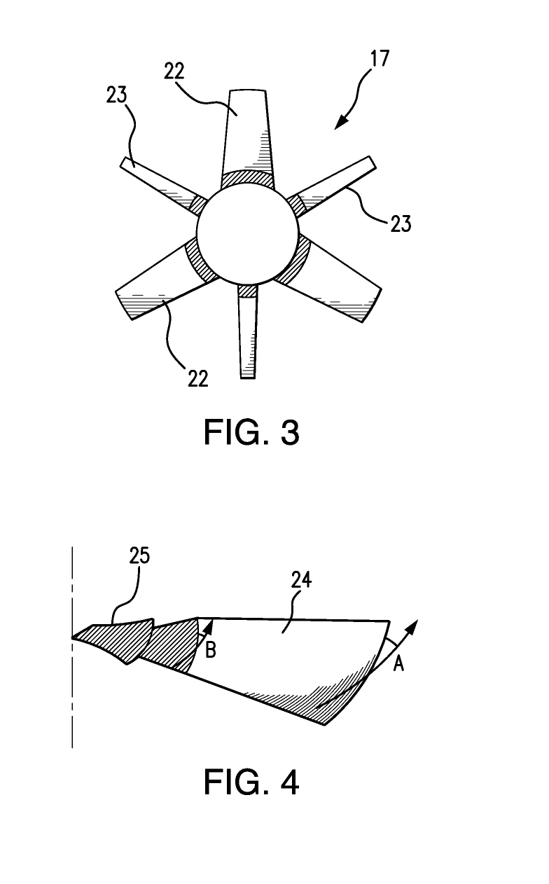

In the embodiment of a ventilator according to the invention shown in FIG. 3, two types of blades 22, 23 that are arranged alternatively and have different shapes are present. In this case, the two blade types 22, 23 each meet the criteria of a width that decreases radially toward the outside.

FIG. 4 illustrates an example of the invention in which the angle of inclination of a blade 24 increases from the outside radially toward the inside up to a hub area 25. The radially inner angle of inclination B shown in the figure is thus greater than the radially outer angle of inclination A.

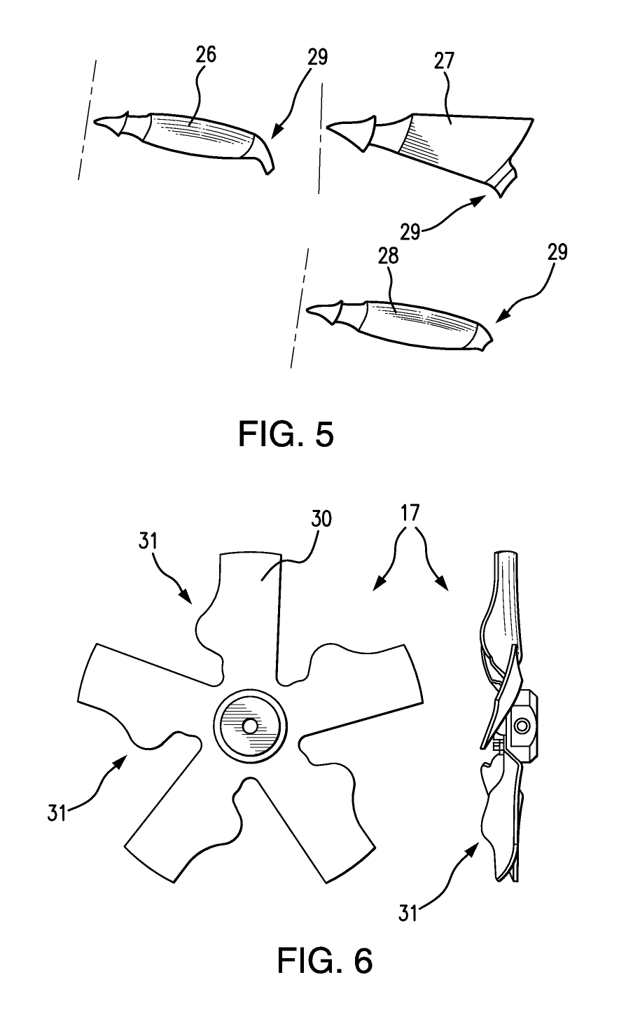

Blades 26, 27, 28 shown in FIG. 5 each have, in a radially outer end area of the blade, an end section 29 that is bent in the axial direction. By means of this end section, an effective generation of turbulence with great spatial depth is already achieved at low rpm values.

The example according to FIG. 6 shows a ventilator according to the invention in an axial top view as well as in a side top view. The ventilator has an uneven number of blades 30, five in this case. Each one of the blades is shaped identically and has a local maximum 31 of its width, where the maximum is located roughly at the halfway point of a maximum radius starting from the rotation axis. In an embodiment example that is not shown, the ventilator has an even number of blades, for example, 4, 6 or 8 blades.

In the present case, the maximum is locally strongly limited, so that, in an axial top view, it has a shape resembling a nose protruding from the blade edge. The local maximum occurs on only one side of the blade, whereas the other blade edge extends substantially along a straight line.

It is understood that the individual characteristics of the different embodiment examples can be reasonably combined with each other, depending on the requirements.

1. A driving tool, comprising
a tank for storing a fuel,
a combustion chamber connected to the tank,
a movable piston for driving a driving ram, and
a ventilator that acts on the combustion chamber and rotates about an axis, with several blades extending radially to the axis, each blade having an inside and an outside,
wherein
at least one of the blades has a section of at least one third, of a radial length of the blade, wherein the section has a projected width in the axial direction that does not increase radially toward the outside, and/or
at least one of the blades has a section of at least one third of a radial length of the blade, wherein the section has an angle of inclination (A, B) around a blade axis that increases from the outside toward the inside.

2. The driving tool according to claim 1, wherein the projected width decreases over the course of the section radially toward the outside.

3. The driving tool according to claim 1, wherein the increase in the angle of inclination (A, B) over the section is at least one tenth of a maximum angle of inclination of the section.

4. The driving tool according to claim 1, wherein at least one first blade having a first shaping and at least one blade having a second shaping that is different from the first shaping are arranged on the ventilator.

5. The driving tool according to claim 1, wherein at least one of the blades has a radially outer end section, wherein the end section is bent in the axial direction with respect to the remaining blade.

6. The driving tool according to claim 5, wherein the end section is turned inward.

7. The driving tool according to claim 1, wherein at least one of the blades has a course with a saber-like curve in the peripheral direction.

8. The driving tool according to claim 1, wherein at least one of the blades has a local maximum of the projected width.

9. The driving tool according to claim 1, wherein at least one of the blades has a section of at least half of the radial length of the blade, wherein the section has a projected width in the axial direction that does not increase radially toward the outside, and/or at least one of the blades has a section of at least half of the radial length of the blade, wherein the section has an angle of inclination (A,B) around a blade axis that increases from the outside toward the inside.

10. The driving tool according to claim 2, wherein the increase in the angle of inclination (A, B) over the section is at least one tenth of a maximum angle of inclination of the section.

11. The driving tool according to claim 2, wherein at least one first blade with a first shaping and at least one blade having a second shaping that is different from the first shaping are arranged on the ventilator.

12. The driving tool according to claim 3, wherein at least one first blade with a first shaping and at least one blade having a second shaping that is different from the first shaping are arranged on the ventilator.

13. The driving tool according to claim 2, wherein at least one of the blades has a radially outer end section, wherein the end section is bent in the axial direction with respect to the remaining blade.

14. The driving tool according to claim 3, wherein at least one of the blades has a radially outer end section, wherein the end section is bent in the axial direction with respect to the remaining blade.

15. The driving tool according to claim 4, wherein at least one of the blades has a radially outer end section, wherein the end section is bent in the axial direction with respect to the remaining blade.

16. The driving tool according to claim 2, wherein at least one of the blades has a section of at least half of the radial length of the blade, wherein the section has a projected width in the axial direction that does not increase radially toward the outside, and/or at least one of the blades has a section of at least half of the radial length of the blade, wherein the section has an angle of inclination (A,B) around a blade axis that increases from the outside toward the inside.

17. The driving tool according to claim 2, wherein the projected width decreases over the course of the section radially toward the outside by at least one tenth over the length of the section.

18. The driving tool according to claim 3, wherein the increase in the angle of inclination (A, B) over the section is at least one fifth of the maximum angle of the section.

19. The driving tool according to claim 17, wherein at least one first blade with a first shaping and at least one blade having a second shaping that is different from the first shaping are arranged on the ventilator.

20. The driving tool according to claim 18, wherein at least one first blade with a first shaping and at least one blade having a second shaping that is different from the first shaping are arranged on the ventilator.
